(19) United States
(12) Patent Application Publication
(10) Pub. No.: US 2026/0249394 A1
(43) Pub. Date: Aug. 27, 2026

(54) LASER METAL DEPOSITION DEVICE WITH WIRE FORCE DETECTION BY A MULTI-AXIS FORCE SENSOR AND METHOD

(71) Applicant: PROCADA AB, Trollhätan (SE)

(72) Inventors: Almir HERALIC, Göteborg (SE); Petter HAGQVIST, Trollhätan (SE)

(73) Assignee: PROCADA AB, Trollhätan (SE)

(21) Appl. No.: 19/163,211

(22) PCT Filed: Apr. 1, 2024
(86) PCT No.: PCT/SE2024/050296

§ 371 Date: Sep. 8, 2025

(30) Foreign Application Priority Data
Apr. 3, 2023 (SE) 2330149-2

(51) Int. Cl. B23K 26/21; B23K 26/08; B23K 26/14; B23K 26/70; B23K 101/32

(52) U.S. Cl. CPC B23K 26/21; B23K 26/0884; B23K 26/1464; B23K 26/702; B23K 2101/32

(57) ABSTRACT

A laser metal deposition device comprising: a wire nozzle for delivering a wire to be deposited on a substrate, a laser source for delivering a laser beam configured to melt the wire, a multi-axes force sensor configured to determine the force between the wire and the substrate, and a controller adapted to control, based on the measured forces by the force sensor, at least one of: output power of the laser source, current supplied to the wire, rate of relative movement of the wire nozzle and laser beam with respect to the substrate, or displacement of the wire and/or wire nozzle with respect to the laser beam in at least one axis.

### FIELD OF THE INVENTION

The present disclosure relates to laser metal deposition devices. In particular it relates to laser metal deposition devices having force feedback control of deposition device output parameters.

### BACKGROUND OF THE INVENTION

Metal additive manufacturing is a technique whereby metal is deposited on a substrate surface. One additive manufacturing technique utilises Laser Metal Deposition of wire systems (LMD-w systems) whereby a metal wire, a strip or band, is melted in a pool of heated material on the substrate, the material being heated via a laser system generally focused on the interface between the wire tip and the substrate.

The metal deposited may be used for welding or cladding applications. During a deposition process the tip of the wire to be deposited and the laser beam are generally moved relative to the substrate on which the deposition occurs. That is, in known laser metal deposition systems, the laser beam and the wire remain in fixed relation to each other, and the laser beam and the wire are moved relative the substrate. The laser source and wire nozzle are typically rigidly connected to a gantry or robot arm which can move the laser source and wire nozzle relative the substrate. In some devices, the laser source and wire nozzle may be maintained in a fixed position whilst the substrate is provided on a movable platform. The platform typically being movable in XY directions.

The fixed relationship between the laser beam and the wire nozzle is intended to minimize for example, inadvertent misalignment.

WO 2021/110793 A1 (Procada AB) describes a control system for maintaining process stability in an additive manufacturing process by determining the conductance between the metal strip, i.e., wire, and adjusting a process parameter based on the measured conductance.

However, improved systems are desirable. For example, when depositing thin beads of material fine control of the deposition process is necessary. A cladding process may require the deposition of beads of less than about 2 mm to a metal substrate. At such small dimensions improved deposition systems, and control systems for depositions are necessary to provide reliable and efficient deposition.

Stubbing is a detrimental process mode in laser metal deposition, whereby solid wire contacts the solid metal below the metal pool. Stubbing causes vibrations of the wire. During stubbing, lack of fusion defects are created. Therefore, to ensure good material quality a smooth transfer of metal needs to be maintained throughout the entire deposition sequence.

Devices, systems and methods which have improved deposition control, and in particular improved recovery from detrimental process modes would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a laser metal deposition device comprising: a wire nozzle for delivering a wire to be deposited on a substrate, a laser source for delivering a laser beam configured to melt the wire, a multi-axes force sensor configured to determine the force between the wire and the substrate, and a controller adapted to control, based on the measured forces by the force sensor, at least one of: output power of the laser source, rate of relative movement of the wire nozzle and laser beam with respect to the substrate, or displacement of the wire and/or wire nozzle with respect to the laser beam in at least one axis.

The force feedback control of deposition output parameters, such output power of the laser source, rate of relative movement of the wire nozzle and laser beam with respect to the substrate, or displacement of the wire and/or wire nozzle with respect to the laser beam in at least one axis, results in improved deposition performance and control. The device is capable of depositing relatively thinner beads of metal with improved performance as variations in for example, wire curvature, wire quality etc. can be corrected for during deposition. Other means of process monitoring methods such as conductance measurements exhibits comparatively lower sensitivity to wire-substrate interactions/stubbing compared to the force measurements.

The wire and/or wire nozzle for delivering the wire to be deposited on the substrate is advantageously adapted to move relative the laser beam.

The multi-axis force sensor is especially advantageous for detecting detrimental process modes. Additionally, when force feedback control is combined with conductance control, the conductance measurements can be used to detect dropping and the force sensor can be used for detecting stubbing or other wire position detrimental process modes. Since the measured force is not a scalar, but a vector entity, it also offers directional information. This gives the opportunity for directional actuation of control response using the multi-axis actuator.

Additionally, as the measured force is a force vector and not a scalar, it can be used to detect complex interactions with the substrate such as stubbing in the direction of the wire feed, forces orthogonal to the feed direction and laser allowing for a multi-axial control response.

A method of operating a laser metal deposition device is provided.

A method of stubbing detection and recovery for a laser metal deposition device is also provided.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1 is a schematic diagram of a laser metal deposition device according to an aspect. Three axes are shown in the diagram, X (general direction of travel), Y (into the page), and Z (vertical, generally parallel to the laser beam). The dashed lines show an example of data transmission and receival, from the force sensor, to and from an actuator.

FIG. 2 is a flow chart of a deposition process according to an aspect.

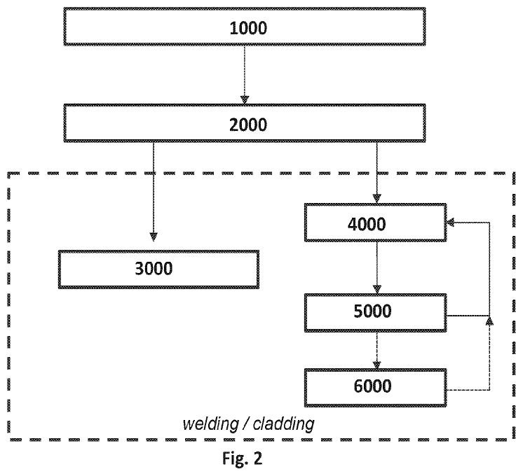

FIG. 3 is a control system diagram showing control of wire position in relation to laser beam based on force measurement.

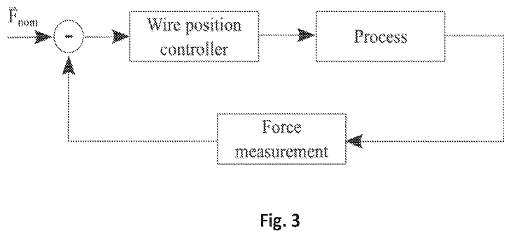

FIG. 4 is a plot of measured z-height, conductance and force components in the Z and Y-axes for an intentionally unstable process. The plot details the results of experiment 2.

### DETAILED DESCRIPTION

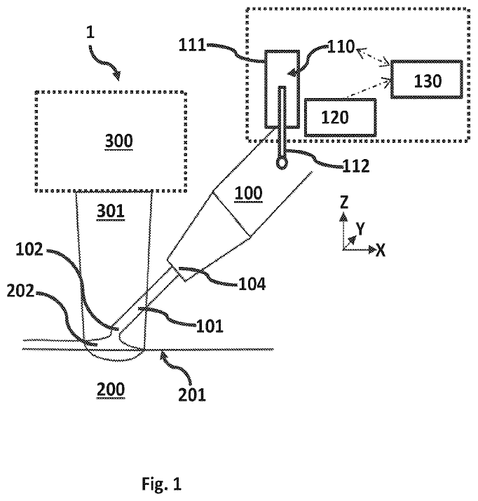

The laser metal deposition of wire (LMD-w) device 1 as shown in FIG. 1 comprises a laser source 300 for providing a laser beam 301 and a wire nozzle 100 for feeding a wire 101. The laser beam 301 is directed towards the substrate 200. The wire nozzle 100 feeds wire 101 towards the substrate 200. The wire 101 is melted at least by the laser beam 301 at the substrate 200. The melting forms a pool of molten material, metal, which can be used to weld or build up layers on the substrate 200. The device 1 comprises a multi-axis force sensor 120 configured to determine the force(s) acting on the wire 101. The device 1 comprises a controller 130 adapted to control at least one of: the output power of the laser source 300, rate of relative movement of the wire nozzle 100 and laser beam 301 with respect to the substrate 200, or location of the wire 101 and/or wire nozzle 100 with respect to the laser beam 301 in at least one axis.

By controlling the output parameters of the laser metal deposition device 1 based on the force measured by the force sensor 120, improved process control is achieved.

The device 1 of FIG. 1 advantageously comprises an actuator 110 operatively connected to the wire nozzle 100 for positioning of the wire nozzle 100, wire 101, and/or wire tip 102 with respect to the laser beam 301. The actuator 110 is configured to displace the wire tip 102, the wire 101, and/or the wire nozzle 100 in at least one axis. The controller 130 and the actuator 110 position the wire tip 102, wire nozzle 100 and/or wire 101 based on the force measured by the force sensor 120.

By controlling the position of the wire 101 with respect to the laser beam 301, based on the force acting on the wire 101, improved deposition is achieved, and relatively thin deposited beads are reliably achievable compared to devices where the wire and laser beam move in unison with respect to the substrate 200.

As stated above, the wire nozzle 100 feeds wire 101 such that wire is melted at the substrate 200 and can be deposited at the substrate 200. The wire nozzle 100 may also be known as a wire feeder 100. Typically wire nozzles 100 feed a coiled spool of wire 101. As the wire is provided on a spool the wire exiting the wire nozzle 100 may have a slight curvature. Such curvature of wire is not typically a problem when depositing relatively thick beads on a substrate 200 as the wire can be maintained within a relatively larger laser beam 301 or relatively larger melt pool 202. However, in deposition processes requiring the deposition of relatively thin beads, such as less than about 2 mm, the curvature of the wire 101 may lead to the wire inadvertently becoming displaced with respect to the laser beam 301. The present device 1 is capable of adjusting the deposition process and for example can be utilised for reliable deposition of relatively thin beads of material.

The wire 101 may have any suitable cross-section for laser metal wire deposition. For example, the wire 101 may have a circular, or rectangular cross-section. Wires 101 having a rectangular cross-section are sometimes referred to as strips or bands in the field.

The actuator 110 is an actuator configured to displace the wire tip 102, the wire 101 and/or the wire nozzle 100 with respect to the laser beam 301 in at least one axis. The single axis is advantageously the Z axis, however, the actuator 110 may control displacement in the X, Y or rotational axis. The actuator 110 may be a multi-axis actuator 110 configured to move the wire nozzle 100, and/or wire 101 in at least two axes. The multi-axis actuator 110 may for example be a ZX or ZY, XY axis actuator, or Z and rotational-axis actuator 110 or any combination thereof. The multi-axis actuator 110 may be a three-axis, XYZ-axis, actuator configured to displace the wire 101 with the respect to the laser beam 301 in at least three-axes. In particular, the actuator 110 is configured to displace the tip 102 of the wire 101 with respect to the laser beam 301. The actuator 110 positions the wire tip 102 relative the laser beam 301. Clearly, positioning the wire tip 102 may be achieved by displacing the wire 101 and/or the wire nozzle 100, as displacement of the wire 101 or wire nozzle 100 will inherently displace the wire tip 102. The actuator 110 is advantageously provided to the wire nozzle 100 such that the wire nozzle 100 is displaced in order to displace and position the wire 101, and in particular the wire tip 102. By providing the actuator at the wire nozzle 100 accurate control of the position of the wire 101 is achieved without the necessity of an additional component for actuating/holding the wire 101. As described, the actuator 110 is configured to displace the wire 101, and in particular the wire tip 102, along the direction of e.g., the Z-axis shown in FIG. 1. The Z-axis is generally a vertical axis and generally parallel to the laser beam 301. A ZY multi-axis actuator 110 is configured to displace the wire 101, and in particular the wire tip 102, along the direction of the Z-axis and Y-axis shown in FIG. 1. The Y-axis is into the page in FIG. 1. A ZX multi-axis actuator 110 is configured to displace the wire 101, and wire tip 102, in a lateral direction with respect to the laser beam 301. The ZX multi-axis actuator 110 is configured to displace the wire 101, in particular the wire tip 102, in the Z-axis and the X-axis as shown in FIG. 1. The X-axis is the direction of travel in the process shown schematically in FIG. 1. Combinations of control in X, Y, Z and/or rotational axes are possible with a multi-axis actuator. The wire feeder/nozzle of a typical laser deposition device is only capable of controlling the wire feed rate. That is, in a typical known device wire is fed from the wire feeder at different rates. The displacement of the wire 101 and wire tip 102 with respect to the laser beam 301, in particular when based on measured force, has been shown to provide improved deposition processes.

As described, the present additive manufacturing device 1 may comprise an actuator 110 in addition to and separate to a wire nozzle 100 mechanism which controls the feed rate of wire 101. Controlling the feed rate alone is not sufficient to overcome the problems with wire displacement during deposition.

As stated above, in addition to displacement in three-axes, the wire 101 may be rotationally displaceable with respect to the laser beam 301 and/or substrate 200. That is, the wire 101 may be displaceable around a rotational axis. The rotational displacement of the wire 101 may be achieved by controlling a rotational axis of a robot arm to which the wire nozzle 100 is attached. Advantageously, the wire 101 is displaceable rotationally around the Z-axis, which corresponds to the incident axis of the laser beam 301. The position of the wire 101 may be rotatable with respect to the substrate 200. The wire 101 may be rotatable around the Y-axis, that is the lateral axis as shown in FIG. 1. The rotational displacement of the wire 101 is controlled based on the force measured by the force sensor 120.

Ideally, the laser source 300 and wire nozzle 100 have 6 degrees of freedom to enable the production of parts having complex geometry. As described above, the wire 101 has additional degrees of freedom with respect to the laser beam 301 due to the actuator 110.

As stated above in traditional laser metal deposition devices, the laser beam 301 and the wire nozzle 100 are configured to move together relative the substrate. This may be achieved by providing the laser source 300 and wire nozzle 100 on a movable gantry or robot arm which moves relative the substrate, it may also be achieved by providing the substrate 200 on a movable stage/platform which can be moved relative a fixed laser source 300 and wire nozzle 100 or a combination of both movable robot/gantry and movable substrate. The term configured to move relative the substrate, includes both actuation of the laser source 300 and wire nozzle 100 relative the substrate, and actuation of the substrate 200 relative the laser source 300 and wire nozzle 100. In the present laser metal deposition device 1 the laser beam 301 and wire nozzle 100 are advantageously configured to move relative the substrate 200, and the wire 101 is displaceable relative the laser beam 301 based on force feedback.

The actuator 110 and laser source 300 may be provided in a fixed relationship to each other. For example, the actuator 110 and laser source 300 may be provided at a distal end i.e., positionable end, of a robot arm. The robot arm to which the actuator 110 and laser source 300 are fixed is capable of movement with respect to the substrate 200. As described above, the substrate 200 may be movable with respect to a fixed laser source 300, in such an arrangement the laser source 300 and actuator 110 are in fixed relationship to each other, and fixed at a single position, whilst the substrate 200 is movable in at least XY-axes with respect to the fixed position of the actuator 110 and laser source 300. As the actuator 110 actuates and displaces the wire nozzle 100, it inherently has elements which displace with respect to each other, meaning that not every component of the actuator 110 need be in a fixed relationship with the laser source 300. The actuator 110 has at least one fixed element 111, and at least one displaceable element 112 which is displaceable with respect to the fixed element 111. The laser source 300 may therefore be considered to be in a fixed relationship with the fixed element 111 of the actuator 110. The fixed element 111 of the actuator defines the position of the actuator 110 with respect to the laser source 300, the displaceable element 112 defines the position of the wire nozzle 100 with respect to the laser beam 301.

The multi-axis force sensor 120 is configured to measure the force acting on the wire 101, and in particular the wire tip 102. The multi-axis force sensor may be a force sensor 120 detecting force components in at least two axes. The multi-axis force sensor 120 may detect force components in XY, XZ, YX, and/or YZ axes. The multi-axis force sensor 120 is advantageously a three-axis, XYZ-axis, force sensor configured to measure the force acting on the wire 101, and in particular the wire tip 102.

The multi-axis force sensor enables improved process control over a single axis force sensor as a single axis alone has been shown to not be sufficient for determining a precise change from optimal deposition conditions. For example, if the wire tip 102 leaves the melt pool 202 laterally, then there may be no significant difference in Z-axis force. However, by combining measurements from the Z-axis and Y-axis such a lateral displacement of the wire tip 102 will be detectable and an output parameter can be adjusted to regain optimal process conditions.

The multi-axis force sensor 120 may advantageously be provided to the wire nozzle 100. The multi-axis force sensor 120 may advantageously be provided in the vicinity of the output tip 104 of the wire nozzle 100. The multi-axis force sensor 120 in such an arrangement indirectly measures the force(s) acting on the wire 101 by measuring the forces acting on the wire nozzle 100. In some instances, the multi-axis force sensor 120 may be provided as an additional component between the output nozzle of the wire nozzle 100 and the wire tip 102. In such an arrangement the wire 101 is in direct connection with the force sensor 120 and the force(s) acting on the wire 101 are measured directly by the force sensor 120.

The multi-axis force sensor 120 has surprisingly been shown to be particular advantageous for detecting multiple, independent or inter-dependent, detrimental process modes, such as runaway (described below) and/or stubbing. During complex deposition processes, such as deposition to non-flat substrates forces having components in different directions act upon the wire 101, and/or the wire nozzle 100, the multi-axis force sensor 120 has been shown to be especially advantageous.

For example, a detrimental process mode is known as “runaway”. The term “runaway” refers to when the wire tip 102 deviates from the melt pool in a lateral direction (Y-axis in FIG. 1). The wire tip 102 may deviate partially from, or fully leave the melt pool 202. Deposition of wire 101 to non-flat substrate surfaces 201, such as substrates having a convex or concave substrates surface 201 may be especially susceptible to such a runway detrimental process mode as the downward force of the wire 101 towards the non-flat substrate surface 201 is applies a lateral force to the wire tip 102. The multi-axis force sensor 120 can detect such a runaway process mode due to the multiple force component measurement.

The force sensor 120 is provided in connection to the controller 130. The force sensor 120 is an input parameter to the controller 130.

The multi-axis force sensor 120 may be any known component, or components, suitable for measuring the force at the wire tip 102. The multi-axis force sensor 120 may for example be a three-axis strain sensor.

The multi-axis actuator 110 and multi-axis force sensor 120 may be incorporated into a single component provided at the attachment point for the wire nozzle 100 to a gantry/robot arm.

The controller 130 may be configured to control the heat energy provided by the laser source 300, wire 101 current for wire heating. The controller 130 may be adapted to control the deposition speed based on the measured force(s), that is the rate of relative movement of the wire nozzle 100 and laser beam 301 with respect to the substrate 200. As described above, the controller 130 may be adapted to control the displacement of the wire 101 and/or wire nozzle 100 with respect to the laser beam 301 in at least one axis.

The controller 130 may be configured to control the actuator 110 and in addition to the actuator 110 may be configured to control the heat energy provided by the laser source 300, wire 101 current for wire heating. The controller 130 may be adapted to control the deposition speed based on the measured force(s). The controller 130 may be configured to control the speed of displacement of the wire nozzle 100 and laser source 300 relative the substrate 200 based on the measured force(s).

By controlling output parameters in addition to the position of the wire 101, wire tip 102, and/or actuator 110 improved process control is achievable leading to improved deposition processes.

The controller 130 is configured to control the actuator 110, and other output parameters based on the force measured by the multi-axis force sensor 120. The controller 130 realises force-feedback based control of a deposition process. The controller 130 may be a P-/PI-/PID feedback controller 130. Other control techniques which are suitable to control the actuator 110 and/or other output parameters such as laser heat energy etc. based on the force measured by the multi-axis force sensor 120 may be utilised such as bang-bang, sliding mode, excitation signal etc. The controller 130 may be implemented by devices known in the art. For example, the controller 130 may be implemented by an FPGA, microcontroller, SoC, single board computer, PLC, PC or a combination thereof.

The controller 130 may be configured to control, for example, the actuator 110 based on one type of force-feedback realisation such as P-/PI-/PID feedback and control the other parameters such as laser heat energy etc. based on a different realisation of force feedback control such as e.g., sliding mode. That is, combinations of the ideal force feedback realisation for a specific output parameter are possible.

If the controller 130 controls only the actuator 110 based on the measured force, the controller 130 may be implemented on device connected exclusively to the actuator 110 and force sensor 120. If the controller 130 controls other output parameters in addition to the position of the wire nozzle 100, and/or wire 101, the controller 130 may be implemented on a device which is connected to, in addition to the actuator 110 and force sensor 120, inputs/outputs controlling and/or measuring laser power, wire current, wire feed rate, laser and wire nozzle XYZ position relative the substrate, wire conductance etc.

Generally, when starting a deposition process, the wire tip 102 is located at a specified and known position within the laser beam 301. The controller 130 may be configured to begin force feedback control of the position of the wire tip 102 at start-up of a deposition process and/or during steady-state operation i.e., when deposition is occurring.

The laser source 300 is a high energy laser source 300 capable of providing a laser beam 301 of sufficient energy to melt the wire 101 and/or the substrate 200. The laser beam 301 forms a melt pool 202 at the surface 201 of the substrate 200. The surface 201 of the substrate 200 may take a variety of shapes, such as flat, convex, concave depending on the deposition process and the part which is being deposited upon.

A method for operating a laser metal deposition device will hereinafter be described. Providing 1000 a wire 101 to be deposited on a substrate 200 via a wire nozzle 100. Providing 2000 a laser beam 301 to the substrate 200 and to the wire 101, in particular the wire tip 102 of the wire 101. The laser beam 301 melts a portion of the substrate 200 and the wire 101 forming a melt pool 202 at the surface 201 of the substrate 200. Heat energy from the laser beam 301 and/or the melt pool 202 melts the wire tip 102. Displacing 3000 the wire 101 and laser beam 301 relative the substrate 200. The displacing 3000 occurs in what is known as the direction of travel i.e., the direction along the substrate 200 the deposited metal is provided. Measuring 4000 the forces acting on the wire 101 in multiple axes via a multi-axis force sensor 120. Controlling 5000, based on the forces measured by the force sensor 120, at least one of the: output power of the laser source 300, current supplied to the wire 101 for wire heating, rate of relative movement of the wire nozzle 100 and laser beam 301 with respect to the substrate 200, or location of the wire 101 and/or wire nozzle 100 with respect to the laser beam 300 in at least one axis. The method may advantageously comprise displacing 6000 the wire 101 relative the laser beam 301 with an actuator 110 operatively connected to the wire nozzle 100 based on the measured force by the multi-axis force sensor 120. The deposition of the wire 101 occurs concurrently to the measuring 4000 and controlling 5000. That is, the displacing 3000 of the wire 101 and the laser beam 301 with respect to the substrate 200 occurs concurrently with the measuring 4000 and controlling 6000. The method may comprise displacing 6000 the wire nozzle 100 and/or wire 101 via the actuator 110 based on the forces measured by the force sensor, and additionally, controlling 5000 at least one of output power of the laser source 300, current supplied to the wire 101 for wire heating, rate of relative movement of the wire nozzle 100 and laser beam 301 with respect to the substrate 200. The displacing 6000 of the wire 101 and wire nozzle 100 may occur in at least two axes.

As described above, the device 1 is especially suitable for methods of detection and recovery from detrimental process modes. A method for detecting and recovering from a detrimental process mode/condition, such as stubbing or runaway, comprises each of the process and, optionally, the optional process steps as detailed above. The method of detrimental process mode detection and recovery may comprise a step of detecting a detrimental process mode based on the forces acting on the wire 101 measured by the multi-axis force sensor 120.

The multi-axis force sensor 120 may advantageously be combined with additional detector components for detecting other parameters of the deposition process. As would be understood to the skilled person, a laser metal deposition device typically receives input data relating to the laser 300 power, wire 101 feed rate, and substrate 200 position. Each of these parameters, alone or ideally in combination, may be detected and provided as input to the controller 130. The force-based control process and device 1 described herein may be advantageously combined with the conductance based control system and device described in WO 2021/110793 A1 (Procada AB). That is, the controller 130 may, in addition to the detected forces via the multi-axis force sensor 120, receive a parameter representing the measured conductance between the wire tip 101 and the substrate 200. The controller 130 may advantageously combine the measured conductance and measured forces by the multi-axis force sensor 120 to maintain process stability, or recover from one or more detrimental process modes.

### Experimental Results

### Experiment 1: Deposition Results With XYZ Position Actuator

The method has successfully been used for depositing titanium-, nickel- and steel alloys in thin layers (~200 μm thick). The thin layers and the subsequently shallow melt pool makes the process excessively sensitive to wire-substrate distance variations with stubbing being a major risk. The force measurements provided from the multi-axis force sensor 120 allowed for automatic detection of incipient stubbing and appropriate mitigations using an XYZ wire position actuator.

The method has been successfully used in detecting unwanted mechanical interactions between the wire and the substrate allowing for automatic process control

### Experiment 2: Detrimental Process Mode Detection by Multi-axis Force Sensor

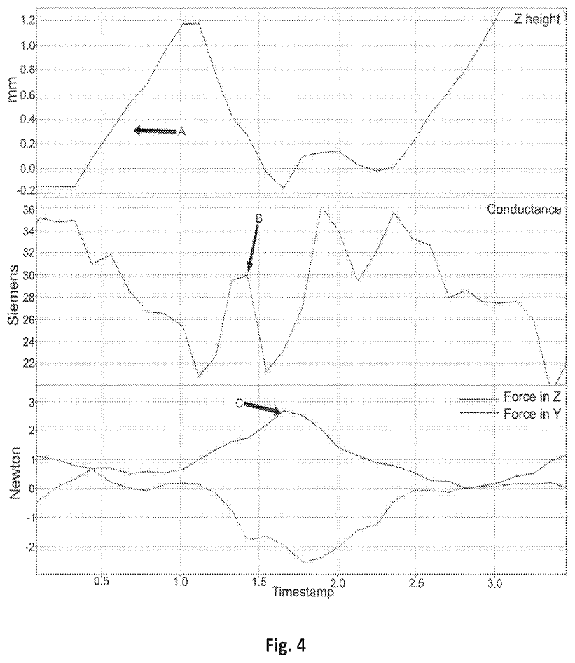

A trial was performed with the intention of evaluating the multi-axis force sensor 120, and control based upon multi-axis force control. The height (Z-axis) controller was controlled such that it was purposely unstable. The controller also received conductance data from a conductance detection and control system. The results of the trial are shown in FIG. 4. The measured forces in the Z-axis and the Y-axis are shown in the graph. The force in the X-axis was measured during the trial, and was used for control purposes, but is, however, not relevant for appreciating the results of the present trial.

Arrow A indicates the expected behavior of the process. As wire 101 height relative to the substrate 200 increases the conductance value decreases, that is, the wire 101 is in reduced contact with the substrate 200. The force in Y/Z remains around 0 N as the wire 101 is further away from the substrate resulting in no difference in the detected forces. As the conductance has decreased, the conductance aspect of the control system will tend to change a parameter in order to increase conductance, in this case Z-height was decreased to increase conductance. This change can be seen in the Z-height graph after the peak (after arrow A) indicating wire being displaced towards the substrate. The reduction in Z-height would be expected to result in the conductance increasing as the “wetting neck” is getting thicker in the melt pool 202. This increase in conductance can be seen when the Z-height reaches a maximum and starts to go down prior to the arrow B. However, during the reduction in Z-height the wire 101 experiences a runaway detrimental process mode.

Arrow B indicates a sharp turn to a lower conductance value, this is due to the runaway wire. The y-force has gotten too high resulting in the wire, partially or fully, leaving the melt pool. The force measurement data shows that both the force in Z and the force in Y have diverged from the 0N line.

Arrow C indicates where the force control of the process disallows the height controller from lowering the actuator, which would further reduce Z-height and, and allows the process to restabilize. In this specific case, the increase in the Y component of the force indicates that the detrimental process mode was a runaway wire, and not stubbing alone, that is, the wire has moved laterally within or even outside the melt pool 202. Control of the Y, ZY, XY, and/or XYZ position of the wire 101, or wire nozzle 100 with respect to the laser beam 301 would have also been a possible control action based on the increasing Y force component.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Furthermore, although individually listed, a plurality of means, elements or method steps may be implemented by e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1-22. (canceled)

23. A laser metal deposition device comprising:
a wire nozzle for delivering a wire to be deposited on a substrate,
a laser source for delivering a laser beam configured to melt the wire,
a multi-axes force sensor configured to determine the forces between the wire and the substrate, and
a controller adapted to control, based on the measured forces by the force sensor, at least one of: output power of the laser source, rate of relative movement of the wire nozzle and laser beam with respect to the substrate, or displacement of the wire and/or wire nozzle with respect to the laser beam in at least one axis.

24. The laser metal deposition device according to claim 23, wherein the device comprises an actuator operatively connected to the wire nozzle and configured to displace the wire nozzle and/or wire with respect to the laser beam in at least one axis, wherein the actuator is controlled by the controller based on the forces measured by the force sensor.

25. The laser metal deposition device according to claim 24, wherein the actuator is a multi-axis actuator configured to displace the wire nozzle and/or wire with respect to the laser beam in at least two axes.

26. The laser metal deposition device according to claim 24, wherein the actuator is configured to displace the wire nozzle and/or wire with respect to the laser beam in at least the Z-axis.

27. The laser metal deposition device according to claim 25, wherein the multi-axis actuator is a three-axis or greater actuator configured to displace the wire in at least three axes.

28. The laser metal deposition device according to claim 23, wherein the controller is configured to control the location of the wire nozzle with respect to the laser beam in at least one axis, and additionally at least one of: output power of the laser source, current supplied to the wire, rate of relative movement of the wire nozzle and laser beam with respect to the substrate.

29. The laser metal deposition device according to claim 23, wherein the multi-axis force sensor is a three-axis, XYZ, force sensor.

30. The laser metal deposition device according to claim 24, wherein the laser source and a fixed element of the actuator are fixed with respect to each other, and wherein the actuator and laser source are configured to move relative the substrate in at least XY-axes.

31. The laser metal deposition device according to claim 23, wherein the multi-axis force sensor is provided at the wire nozzle, such that the force acting on the wire nozzle is measurable.

32. The laser metal deposition device according to claim 24, wherein the actuator is separate to and in addition to the wire nozzle for controlling the feed rate of the wire.

33. The laser metal deposition device according to claim 23, wherein in addition to controlling based on the measured force, at least one of: output power of the laser source, rate of relative movement of the wire nozzle and laser beam with respect to the substrate, or displacement of the wire and/or wire nozzle with respect to the laser beam in at least one axis; the controller is configured to control the current supplied to the wire based on the measured force.

34. The laser metal deposition device according to claim 23, wherein the controller is adapted to control, in addition to the actuator, at least one of: the heat provided by the laser source, current to the wire, and rate of relative movement of the wire nozzle and laser beam with respect to the substrate based on the measured force.

35. A method for operating a laser metal deposition device comprising:
providing a wire to be deposited on a substrate via a wire nozzle,
providing a laser beam to the substrate via a laser source,
displacing the wire and laser beam relative the substrate to deposit melted wire in a direction of travel,
measuring the forces acting on the wire in multiple axes via a multi-axis force sensor, and
controlling based on the forces measured by the multi-axis force sensor at least one of: output power of the laser source, rate of relative movement of the wire nozzle and laser beam with respect to the substrate, or location of the wire and/or wire nozzle with respect to the laser beam in at least one axis.

36. The method for operating a laser metal deposition device according to claim 35, wherein the controlling based on the forces measured by the force sensor comprises:
displacing in at least one axis, the wire and/or wire nozzle relative the laser beam via an actuator operatively connected to the wire nozzle.

37. The method according to claim 36, wherein the displacing of the wire and/or wire nozzle relative the laser beam via the actuator, occurs in at least two axes.

38. The method according to claim 36, wherein the controlling based on the forces measured by the force sensor comprises, controlling additionally at least one of: output power of the laser source, current supplied to the wire, or rate of relative movement of the wire nozzle and laser beam with respect to the substrate.

39. The method according to claim 36, wherein the actuator is configured to displace the wire nozzle with respect to the laser beam.

40. The method according to claim 35, wherein the multi-axis force sensor is provided at the wire nozzle.

41. The method according to claim 35, wherein the measuring the forces acting on the wire and displacing the wire relative the laser beam occurs concurrently to the displacing of the wire relative the substrate.

42. The method according to claim 35, wherein in addition to controlling, based on the measured force, at least one of: output power of the laser source, rate of relative movement of the wire nozzle and laser beam with respect to the substrate, or displacement of the wire and/or wire nozzle with respect to the laser beam in at least one axis; the controller is configured to control the current supplied to the wire based on the measured force.

43. A method of detrimental process mode detection and recovery for a laser metal deposition device, the device comprising a wire nozzle for providing a wire to be deposited on a substrate, and a laser source for providing a laser beam; the method comprising:
measuring the forces acting on the wire in multiple axes via a multi-axis force sensor, and
based on the forces measured by the force sensor, controlling at least one of: output power of the laser source, current supplied to the wire, rate of relative movement of the wire nozzle and laser beam with respect to the substrate, or location of the wire nozzle with respect to the laser beam in at least one axis.

44. The method according to claim 43, wherein the detrimental process mode is stubbing and/or runaway.
